(19) United States
(12) Patent Application Publication
(10) Pub. No.: US 2005/0079479 A1
(43) Pub. Date: Apr. 14, 2005

(54) CONTAINER ASSEMBLY INCLUDING A MAGNETIC DISPLAY PANEL ON A CONTAINER BODY

(75) Inventor: Ying-Che Chen, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Great Truth Co., Ltd., Rosemead, CA (US)

(21) Appl. No.: 10/683,662

(22) Filed: Oct. 9, 2003

(51) Int. Cl. B43L 1/00

(52) U.S. Cl. 434/409

(57) ABSTRACT

A container assembly includes a container body, a magnetic display panel, a magnetic pen, and a magnetic eraser. The magnetic display panel is mounted on an outer wall surface of the container body, and has a rear side confronting the container body and an opposite front side. The magnetic display panel has a multi-cellular configuration, and includes a cell array and a dispersion contained in the cell array. The dispersion contains magnetic particles. The magnetic pen is used to move the magnetic particles in the cell array to the front side of the magnetic display panel so as to form an image thereat. The magnetic eraser is used to move the magnetic particles in the cell array to the rear side of the magnetic display panel so as to erase the image formed by the magnetic particles at the front side of the magnetic display panel.

### BACKGROUND OF THE INVENTION

1. Field of the Invention

The invention relates to a container assembly, more particularly to a container assembly that includes a magnetic display panel on a container body.

2. Description of the Related Art

Magnetic display devices are well known in the art. A conventional magnetic display device includes a magnetic display panel, a magnetic pen, and a magnetic eraser. The magnetic display panel has a multi-cellular configuration, and includes a cell array and a dispersion contained in the cell array. The dispersion contains magnetic particles. The magnetic pen is operably associated with the magnetic display panel for moving the magnetic particles in the cell array to a front side of the magnetic display panel so as to form an image at the front side of the magnetic display panel. The magnetic eraser is operably associated with the magnetic display panel for moving the magnetic particles in the cell array to a rear side of the magnetic display panel so as to erase the image formed by the magnetic particles at the front side of the magnetic display panel.

At present, the conventional magnetic display devices are implemented as independent devices dedicated solely to a display purpose, such as in the form of toys that appeal to children. As such, occasions where the conventional magnetic display devices are in use are considered to be generally infrequent. There is thus a need to enhance utility of the conventional magnetic display devices.

### SUMMARY OF THE INVENTION

Therefore, the object of the present invention is to provide a container assembly that includes a magnetic display panel on a container body so as to overcome the aforesaid drawbacks of the prior art.

Accordingly, a container assembly of this invention comprises a container body that has an outer wall surface, a magnetic display panel, a magnetic pen, and a magnetic eraser. The magnetic display panel is mounted on the outer wall surface, and has a rear side confronting the container body and a front side opposite to the rear side. The magnetic display panel has a multi-cellular configuration, and includes a cell array and a dispersion contained in the cell array. The dispersion contains magnetic particles. The magnetic pen is operably associated with the magnetic display panel for moving the magnetic particles in the cell array to the front side of the magnetic display panel so as to form an image at the front side of the magnetic display panel. The magnetic eraser is operably associated with the magnetic display panel for moving the magnetic particles in the cell array to the rear side of the magnetic display panel so as to erase the image formed by the magnetic particles at the front side of the magnetic display panel.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a container assembly according to the present invention;

FIG. 2 is an assembled perspective view of the preferred embodiment;

FIG. 3 is a fragmentary sectional view of a container body of the preferred embodiment, taken along line III-III in FIG. 1; and

FIG. 4 is a fragmentary sectional view of a magnetic display panel of the preferred embodiment.

### DETAILED DESCRIPTION OF THE PREFERRED EMBODIMENT

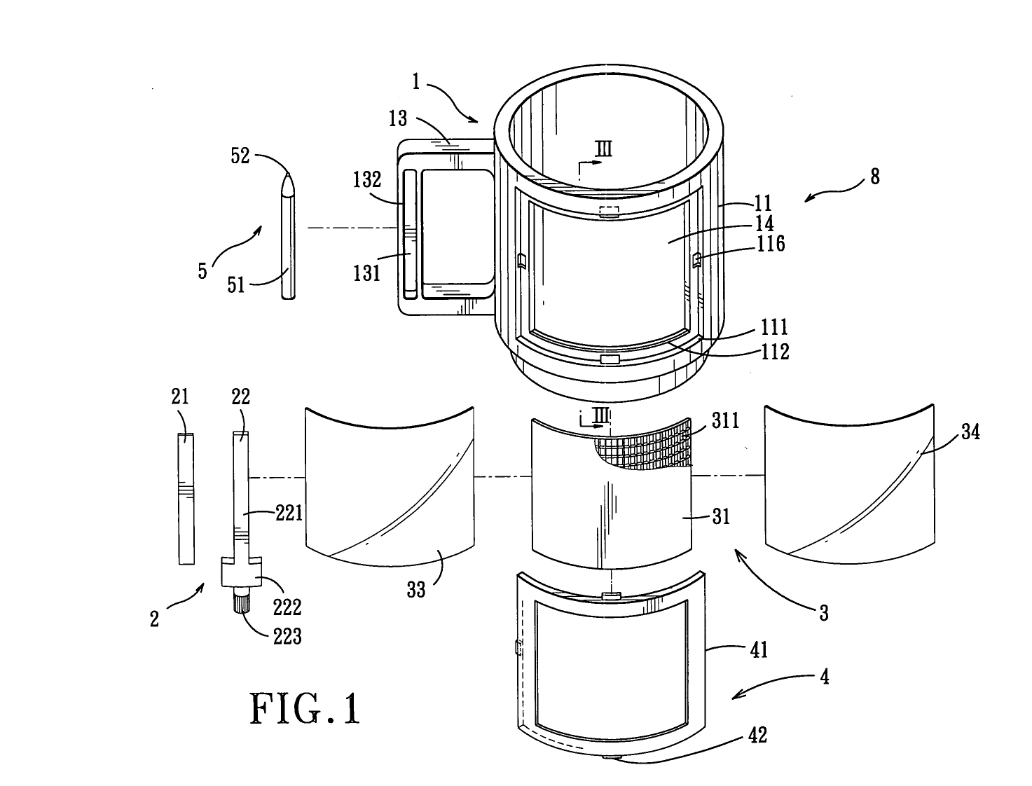

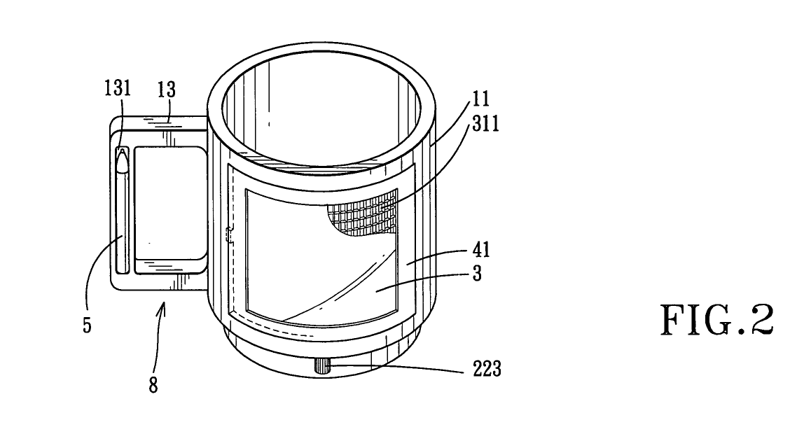

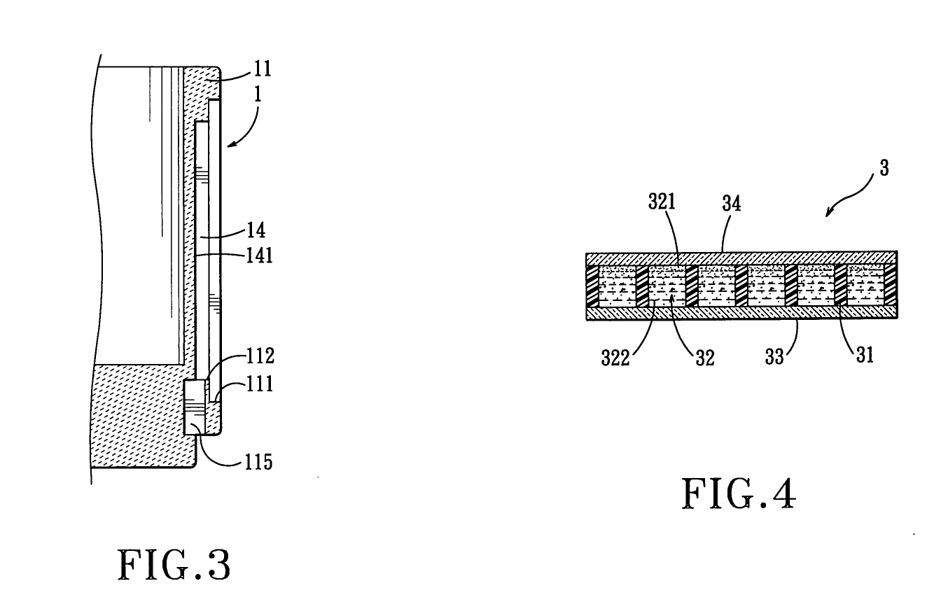

Referring to FIGS. 1 to 4, the preferred embodiment of a container assembly 8 according to the present invention is shown to comprise a container body 1 that has an outer wall surface 11, a magnetic display panel 3, a magnetic pen 5, and a magnetic eraser 2.

In this embodiment, the container body 1 is a mug. In practice, the container body 1 should not be limited thereto, and may instead be in the form of a cup, a pencil box, a pen holder, a coin bank, a canister, a lunch box, a vase, a pot, a bag, a picture frame, or a mailbox. In addition, the container body 1 may be made of plastic, glass, ceramic, etc.

The outer wall surface 11 of the container body 1 is formed with a recess 14. The recess 14 has a bottom 141, and a rectangular periphery that includes an inner peripheral portion 112 extending from the bottom 141, and an outer peripheral portion 111 distal from the bottom 141. The recess 14 is wider at the outer peripheral portion 111 than at the inner peripheral portion 112. The container body 1 is further formed with a slide groove 115 that is disposed inwardly of the outer peripheral portion 111 and that is in spatial communication with the recess 14. In this embodiment, the container body 1 has a handle 13. The handle 13 is formed with a pen-retaining groove 131 for receiving removably the magnetic pen 5, and has a stop rib 132 projecting into the pen-retaining groove 131 for retaining removably the magnetic pen 5 in the pen-retaining groove 131. In practice, the magnetic pen 5 may be mounted removably instead on the outer wall surface 11 of the container body 1.

The magnetic display panel 3 is mounted in the recess 14, and has a rear side confronting the container body 1 and a front side opposite to the rear side. The magnetic display panel 3 has a multi-cellular configuration, and includes a cell array 311 and a dispersion 32 contained in the cell array 311. The dispersion 32 contains dark-colored magnetic particles 321 and a light-colored oily liquid dispersion medium 322. In structure, the magnetic display panel 3 includes a backing plate 33 at the rear side of the magnetic display panel 3, a light-transmissive display plate 34 at the front side of the magnetic display panel 3, and a grid member 31 sandwiched between the backing plate 33 and the display plate 34 and defining the cell array 311 that contains the dispersion 32. The grid member 31 may be a rectangular grid member or a honeycomb grid member.

The magnetic pen 5 includes a pen body 51 and a magnetic writing core 52, and is operably associated with the magnetic display panel 3 for moving the magnetic particles 321 in the cell array 311 to the front side of the magnetic display panel 3 so as to form an image at the front side of the magnetic display panel 3 in a conventional manner.

The magnetic eraser 2 includes a permanent magnet rod 21 mounted on a magnet support 22 that is movably extended into the recess 14 via the slide groove 115 so as to be disposed between the bottom 141 and the backing plate 33. The magnet support 22 includes an elongate portion 221 mounted with the permanent magnet rod 21 and disposed in the recess 14, a slide block 222 connected to the elongate portion 221 and received in the slide groove 115 for sliding engagement with the container body 1, and an operating member 223 connected to the slide block 222, disposed outwardly of the recess 14 and the slide groove 115, and operable so as to drive movement of the magnetic eraser 2 relative to the container body 1. The magnetic eraser 2 is operably associated with the magnetic display panel 3 for moving the magnetic particles 321 in the cell array 311 to the rear side of the magnetic display panel 3 so as to erase the image formed by the magnetic particles 321 at the front side of the magnetic display panel 3 in a conventional manner.

The container assembly 8 further comprises a retaining unit 4 mounted to the outer peripheral portion 111 for retaining the magnetic display panel 3 in the recess 14. The retaining unit 4 includes a retaining frame 41 and an interlocking unit to lock the retaining frame 41 onto the outer peripheral portion 111. In this embodiment, the interlocking unit is constituted by a plurality of engaging blocks 42 on the retaining frame 41, and a plurality of engaging notches 116 in the outer peripheral portion 111 to engage the engaging blocks 42, respectively. Alternatively, the engaging blocks maybe formed on the container body 1, while the engaging notches may be formed in the retaining frame 41. In yet another embodiment, the engaging blocks may be formed directly on the magnetic display panel 3 to engage the engaging notches 116 in the outer peripheral portion 111.

In practice, when drawing an image on the magnetic display panel 3, the magnetic pen 5 is removed from the container body 1, and the magnetic writing core 52 is operated to move over the display plate 34, thereby attracting the magnetic particles 321 toward the display plate 34. When the magnetic writing core 52 is moved away from the display plate 34 such that the magnetic attraction disappears, the magnetic particles 321 will stay proximate to the display plate 34 by virtue of the surface tension of the oily liquid dispersion medium 322. In this manner, a desired image is thus formed. On the other hand, to erase an image on the magnetic display panel 3, the magnetic eraser 2 is slid to attract the magnetic particles 321 toward the backing plate 33. When the magnetic attraction attributed to the magnetic eraser 2 disappears, the magnetic particles 321 will stay proximate to the backing plate 33 by virtue of the surface tension of the oily liquid dispersion medium 322. In this manner, the image on the magnetic display panel 3 is thus erased.

Because the container assembly 8 of this invention incorporates a magnetic display panel 3 with a container body 1, utility of the container assembly 8 is greatly enhanced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A container assembly comprising:
a container body having an outer wall surface;
a magnetic display panel mounted on said outer wall surface and having a rear side confronting said container body and a front side opposite to said rear side, said magnetic display panel having a multi-cellular configuration and including a cell array and a dispersion contained in said cell array, said dispersion containing magnetic particles, said magnetic display panel further including:
a backing plate at said rear side of said magnetic display panel;
a light-transmissive display plate at said front side of said magnetic display panel; and
a grid member sandwiched between said backing plate and said display plate and defining said cell array that contains said dispersion;
a magnetic pen operably associated with said magnetic display panel for moving said magnetic particles in said cell array to said front side of said magnetic display panel so as to form an image at said front side of said magnetic display panel; and
a magnetic eraser operably associated with said magnetic display panel for moving said magnetic particles in said cell array to said rear side of said magnetic display panel so as to erase the image formed by said magnetic particles at said front side of said magnetic display panel;
wherein said outer wall surface of said container body is formed with a recess for mounting said magnetic display panel therein.

2. The container assembly as claimed in claim 15, wherein said magnetic display panel includes:
a backing plate at said rear side of said magnetic display panel;
a light-transmissive display plate at said front side of said magnetic display panel; and
a grid member sandwiched between said backing plate and said display plate and defining said cell array that contains said dispersion.

3. The container assembly as claimed in claim 2, wherein said outer wall surface of said container body is formed with a recess for mounting said magnetic display panel therein.

4. The container assembly as claimed in claim 3, wherein said recess has a bottom, and said magnetic eraser includes a permanent magnet rod movably extended into said recess so as to be disposed between said bottom and said backing plate.

5. The container assembly as claimed in claim 4, wherein said magnetic eraser further includes a slide block connected to said permanent magnet rod and in sliding engagement with said container body, and an operating member connected to said slide block and operable so as to drive movement of said magnetic eraser relative to said container body.

6. The container assembly as claimed in claim 5, wherein said container body is formed with a slide groove that is in spatial communication with said recess, said slide block being slidably disposed in said slide groove, said operating member being disposed outwardly of said recess and said slide groove.

7. The container assembly as claimed in claim 3, further comprising a retaining unit mounted on a periphery of said recess for retaining said magnetic display panel in said recess.

8. The container assembly as claimed in claim 7, wherein said retaining unit includes a retaining frame and an interlocking unit to lock said retaining frame onto said periphery of said recess, said interlocking unit being constituted by a plurality of engaging blocks on one of said retaining frame and said periphery of said recess, and a plurality of engaging notches in the other one of said retaining frame and said periphery of said recess to engage said engaging blocks, respectively.

9. The container assembly as claimed in claim 1, wherein said magnetic pen is mounted removably on said container body.

10. The container assembly as claimed in claim 1, wherein said container body has a handle, and said magnetic pen is mounted removably on said handle.

11. The container assembly as claimed in claim 16, wherein said handle is formed with a pen-retaining groove for receiving removably said magnetic pen.

12. The container assembly as claimed in claim 11, wherein said handle has a stop rib projecting into said pen-retaining groove for retaining removably said magnetic pen in said pen-retaining groove.

13. The container assembly as claimed in claim 1, wherein said dispersion includes a light-colored oily liquid dispersion medium.

14. The container assembly as claimed in claim 1, wherein said container body is a mug.

15. A container assembly comprising:
a container body having an outer wall surface;
a magnetic display panel mounted on said outer wall surface and having a rear side confronting said container body and a front side opposite to said rear side, said magnetic display panel having a multi-cellular configuration and including a cell array and a dispersion contained in said cell array, said dispersion containing magnetic particles;
a magnetic pen removably mounted on said container body and operably associated with said magnetic display panel for moving said magnetic particles in said cell array to said front side of said magnetic display panel so as to form an image at said front side of said magnetic display panel; and
a magnetic eraser operably associated with said magnetic display panel for moving said magnetic particles in said cell array to said rear side of said magnetic display panel so as to erase the image formed by said magnetic particles at said front side of said magnetic display panel.

16. A container assembly comprising:
a container body having an outer wall surface and a handle;
a magnetic display panel mounted on said outer wall surface and having a rear side confronting said container body and a front side opposite to said rear side, said magnetic display panel having a multi-cellular configuration and including a cell array and a dispersion contained in said cell array, said dispersion containing magnetic particles;
a magnetic pen removably mounted on said handle and operably associated with said magnetic display panel for moving said magnetic particles in said cell array to said front side of said magnetic display panel so as to form an image at said front side of said magnetic display panel; and
a magnetic eraser operably associated with said magnetic display panel for moving said magnetic particles in said cell array to said rear side of said magnetic display panel so as to erase the image formed by said magnetic particles at said front side of said magnetic display panel.

17. A container assembly comprising:
a container body comprising a mug and having an outer wall surface;
a magnetic display panel mounted on said outer wall surface and having a rear side confronting said container body and a front side opposite to said rear side, said magnetic display panel having a multi-cellular configuration and including a cell array and a dispersion contained in said cell array, said dispersion containing magnetic particles;
a magnetic pen operably associated with said magnetic display panel for moving said magnetic particles in said cell array to said front side of said magnetic display panel so as to form an image at said front side of said magnetic display panel; and
a magnetic eraser operably associated with said magnetic display panel for moving said magnetic particles in said cell array to said rear side of said magnetic display panel so as to erase the image formed by said magnetic particles at said front side of said magnetic display panel.
